(19) United States
(12) Patent Application Publication
(10) Pub. No.: US 2020/0342478 A1
(43) Pub. Date: Oct. 29, 2020

(54) Machine-Learning Data Processing System with Current Value Model

(71) Applicant: Fair IP, LLC, Santa Monica, CA (US)

(72) Inventors: Ruslana Dalinina, West Hills, CA (US); Abhishek Barnwal, Santa Monica, CA (US); David Scott Boren, Woodland Hills, CA (US); Paul Joseph Fortin, Bolingbrook, IL (US); David Luan Nguyen, Playa Vista, CA (US)

(21) Appl. No.: 16/859,384

(22) Filed: Apr. 27, 2020

Related U.S. Application Data
(60) Provisional application No. 62/839,366, filed on Apr. 26, 2019.

(51) Int. Cl. G06Q 30/02; G06F 16/23; G06Q 10/08; G06Q 30/06; G06Q 40/02; G06N 20/00

(52) U.S. Cl. CPC G06Q 30/0206; G06F 16/2379; G06Q 10/087; G06Q 30/0278; G06N 20/00; G06Q 30/0631; G06Q 30/0201; G06Q 40/02; G06Q 30/0623

(57) ABSTRACT

An embodiment provides a data processing system comprising a processor coupled to a memory for storing a machine learning current value model trained to output a prediction of current value, the machine learning current value model representing a set of vehicle features and historical secondary market transaction values. The processor is configured to create a set of inventory records. The processor is further configured to extract a set of vehicle attributes for a respective vehicle from an inventory record, create a feature vector for the respective vehicle based on the set of vehicle attributes extracted from the inventory record, determine a current value for the respective vehicle by processing the feature vector for the respective vehicle using the machine learning current value model and update the inventory record for the respective vehicle by adding the current value for the respective vehicle to the inventory record for the respective vehicle.

### RELATED APPLICATIONS

This application claims the benefit of priority under 35 U.S.C. § 119(e) to U.S. Provisional Patent Application No. 62/839,366 filed Apr. 26, 2019, entitled “Machine-Learning Data Processing System with Current Value Model,” which is hereby fully incorporated herein by reference for all purposes.

### COPYRIGHT NOTICE

A portion of the disclosure of this patent document contains material to which a claim for copyright is made. The copyright owner has no objection to the facsimile reproduction by anyone of the patent document or the patent disclosure, as it appears in the Patent and Trademark Office patent file or records, but reserves all other copyright rights whatsoever.

### BACKGROUND

Since the widespread adoption of the internet, internet-based systems that facilitate purchasing various goods and services have become increasingly popular tools for both consumers and sellers. In the automotive sector, for example, consumers often use intermediary search sites to search a large number of vehicles available from multiple dealers have become popular. An intermediary site may, for example, allow users to purchase (buy, lease, subscribe to) used vehicles available from multiple dealers through the site.

Consumers are often left to browse all available inventory, with the consumer potentially providing simple filter criteria to narrow available inventory. As such, system resources and time are spent allowing consumers to browse vehicles for which a transaction is not likely to be completed. It may therefore be desirable to limit the vehicles made available through the intermediary site to vehicles that are priced such that consumers are more likely to purchase the vehicles or such that the vehicles can meet desired metrics of the intermediary site. Considering that each used vehicle is inherently unique in nature, this presents various complexities to for sales. Namely, it is difficult to determine if dealers have priced vehicles fairly or priced the vehicles so that the metrics of the intermediary site can be met.

### SUMMARY

Embodiments described herein provide a machine learning current value model trained to output a prediction of current value, the machine learning current value model representing a set of vehicle features and historical secondary market transaction price. The current value output for a vehicle can be used to filter the vehicle from a system or provide a basis for surfacing the vehicle a particular consumer or type of consumer.

One embodiment includes a data processing system comprising a processor and a memory for storing vehicle inventory records and a machine learning current value model representing a set of vehicle features and historical secondary market transaction price and trained to output a prediction of current values for vehicles. According to one embodiment, the processor is configured to receive electronic vehicle data regarding vehicles available from multiple sources and store the vehicle data in a set of inventory records where each inventory record in the set of inventory records includes a set of vehicle attributes for a respective available vehicle. For each inventory record, the processor can extract the set of vehicle attributes for the respective available vehicle, create a feature vector for the respective available vehicle based on the set of vehicle attributes extracted from the inventory record for the respective available vehicle, determine a current value for the respective available vehicle by processing the feature vector for the respective available vehicle using the machine learning current value model, and update the inventory record for the respective available vehicle by adding the current value for the respective available vehicle to the inventory record for the respective available vehicle.

Another embodiment can include a non-transitory computer readable medium embodying thereon computer program code, the computer program code comprising instructions for executing a machine learning current value model trained to output a prediction of current value, the machine learning current value model representing a set of vehicle features and historical secondary market transaction values. The computer program code may also include instructions for receiving electronic vehicle data regarding vehicles available from multiple sources and storing the vehicle data in a set of inventory records where each inventory record in the set of inventory records includes a set of vehicle attributes for a respective available vehicle. The computer program code may also include instructions for extracting the set of vehicle attributes from each inventory record and creating feature vectors for the respective available vehicles based on the sets of vehicle attributes extracted from the inventory records. The computer program code may also include instructions for determining a current value for a respective available vehicle by processing the feature vector for the respective available vehicle using the machine learning current value model and updating the inventory record for the respective available vehicle by adding the current value for the respective available vehicle to the inventory record for the respective available vehicle.

According to one embodiment, the set of vehicle features represented by a feature vector comprises make, model, trim, age, mileage, exterior color, body type, fuel type, drive type, price trend data and condition.

According to one embodiment, the machine learning current value model comprises a first machine learning model trained to output an initial prediction of current value, the first machine learning model representing a first set of vehicle features and a first set of historical secondary market transaction values. The machine learning current value model may also comprise an adjustment to be applied to the initial predication of current value, the adjustment associated with a second set of vehicle features. By way of example, but not limitation, the adjustment comprises a vehicle condition adjustment.

According to one embodiment, an auxiliary model is provided. The auxiliary model may be trained to quantify a relationship between secondary market transaction value and condition. The auxiliary model may represent a second set of vehicle features and a second set of historical secondary market values. The first set of vehicle features used by the first machine learning model may be a different set of features than used by the auxiliary model. For example, according to one embodiment, the first set of vehicle features comprises make, model, trim, age, mileage, exterior color, body type, fuel type, drive type, price trend data, and secondary market transaction price, and the second set of vehicle features comprises features representing make, model, year, mileage, condition and secondary market transaction price. According to one embodiment, the adjustment comprises the auxiliary model. According to another embodiment, the adjustment comprises coefficients derived from the auxiliary model.

According to one embodiment, determining the current value for the respective vehicle comprises using the first machine learning model to determine an initial current value for the respective vehicle and applying a coefficient determined from the auxiliary model to adjust the initial current value for the respective vehicle to determine a final current value for the respective vehicle based on a specified condition grade for the respective vehicle.

Embodiments may include receiving a request from a client device associated with a user to browse vehicles, determining a set of payment information associated with the user, determining a set of qualified vehicles for the user, and returning a user interface page to the client device to allow the user to browse the set of qualified vehicles determined for the user. According to one embodiment, each vehicle in the set of qualified vehicles is determined to be qualified based on the set of payment information associated with the user and the current value determined for that qualified vehicle by the machine learning current value model.

Embodiments may include training the machine learning current value model. According to one embodiment, for example, secondary market transaction data regarding multiple secondary market transactions involving vehicles sold on a secondary market (secondary market vehicles) is received. The secondary market transaction data may be stored in a set of secondary market transaction records. Each secondary market transaction record in the set of secondary market transaction records may store a set of attributes for a respective secondary market vehicle. According to one embodiment, the set of attributes for the respective secondary market vehicle including attributes for secondary market transaction price, make, model, age, mileage, exterior color, body type, fuel type, drive type, and price trend data for the respective secondary market vehicle. A secondary market transaction feature vector may be created from each secondary market transaction record to create a set of secondary market transaction feature vectors. Each secondary market transaction feature vector can represent the set of attributes from the respective secondary market transaction record. The machine learning current value model can be trained using the set of secondary market transaction records.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore non-limiting, embodiments illustrated in the drawings, wherein identical reference numerals designate the same components. Note that the features illustrated in the drawings are not necessarily drawn to scale.

FIG. 1 is a diagrammatic representation of one embodiment of a network topology.

FIG. 2 is a diagrammatic representation of one embodiment of a modelling system training a current value model.

FIG. 3 is a flow chart of one embodiment of a method of determining trend data.

FIG. 4 is a diagrammatic representation of one embodiment of inventory processing.

FIG. 5 is a flow chart illustrating one embodiment of returning inventory items to a user.

FIG. 6 illustrates one embodiment of a user interface in a client mobile device.

FIG. 7 is a diagrammatic representation of a distributed network environment.

### DETAILED DESCRIPTION

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the embodiments in detail. It should be understood, however, that the detailed description and the specific examples are given by way of illustration only and not by way of limitation. Various substitutions, modifications, additions and/or rearrangements within the spirit and/or scope of the underlying inventive concept will become apparent to those skilled in the art from this disclosure.

Before discussing embodiments in more detail a brief description of the context in which embodiments can be utilized may be helpful. Embodiments relate to a rules-based data processing system. More particularly, embodiments relate to a rules/model-based data processing system that incorporates a machine learning current value model (CVM) that represents features of assets and is configured to determine a current value of an inventory item. In one embodiment, an inventory item record can be processed to extract features of an inventory item and the features processed using the CVM to determine a current value for the inventory item. The current value can be used to filter the inventory item, enhance search results or otherwise affect the processing of the system. In some embodiments, the CVM includes a first machine-learning model that outputs an initial prediction of current value and additional adjustments that may be applied to adjust the initial prediction of current value to a final prediction of current value. In some embodiments, the adjustments include one or more additional models, where the outputs of the additional models are applied to the initial prediction of current value to determine a final prediction of current value. In yet other embodiments the CVM comprises a single model that is configured to output the final prediction of current value.

According to one embodiment, a system receives inventory feeds from remote sources, enhances the inventory data with data from distributed sources and filters inventory records down to a set of inventory records for assets (e.g., vehicles) based on rules/models. The computer system provides a program pool of assets that reduces the large number of assets that a consumer must typically search through to a set of assets that are fairly priced. According to one aspect of the present disclosure, the computer system receives inventory records from remote sources, enhances the inventory records with information from other, distributed sources, and applies “fair value” rules to the inventory records to filter the inventory items down to a program pool of inventory items that have a “fair value” based on the fair value rules. In accordance with one embodiment, the fair value rules are selected such that each inventory item (e.g., vehicle) in the program pool is priced close to its wholesale value or other value at the time of sale and can be accurately and competitively priced based, for example, on the output of a machine learning model and selected metrics.

According to one embodiment, the computer system applies the CVM to the program pool of inventory records to accurately determine an initial payment and monthly (or other periodic) payments for each inventory item. The payments may be selected to meet particular metrics. The payments for an inventory item can be pre-calculated before an inventory item is presented to a consumer making the system more efficient, particularly over a large number of inventory records.

The inventory items made available for selection by the user in the client application may be specifically curated for that user by the computer system based on the user's ability to afford the inventory items. As noted above, the computer system can pre-calculate the payment schedules for each inventory items and independently “pre-approve” financing for the consumer. The computer can thus limit the inventory items presented to the user based on the user's approved payment amount.

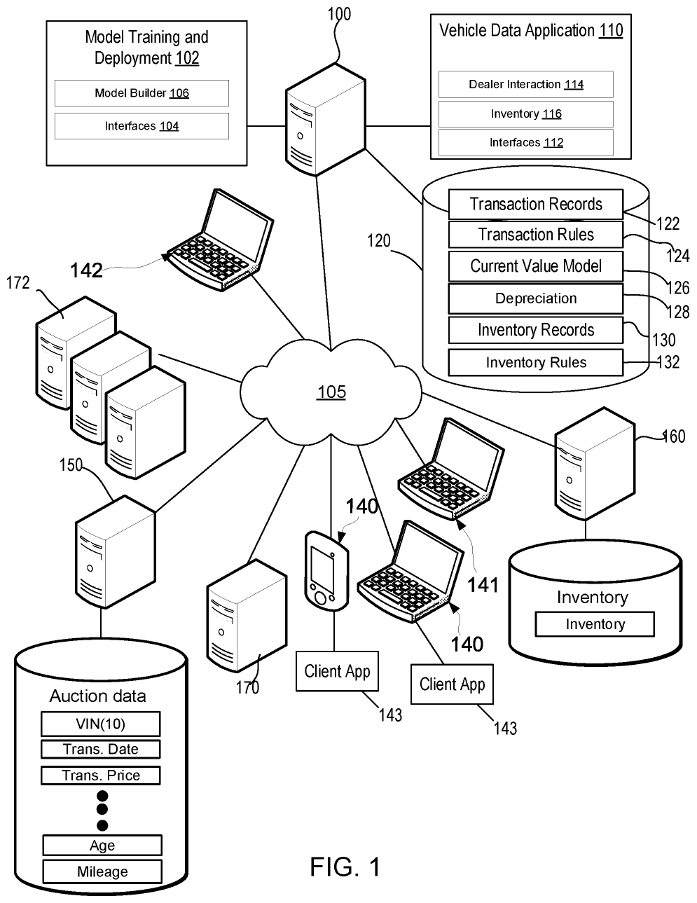

Embodiments of the systems and methods of the present invention may be better explained with reference to FIG. 1, which depicts one embodiment of a topology which may be used to implement certain embodiments. The network topology of FIG. 1 comprises an automotive data processing system 100 which is coupled through network 105 to client computing devices 140, 141, 142 (e.g. computer systems, personal data assistants, smart phones or other client computing devices). The topology of FIG. 1 further includes one or more information provider systems 150 that provide secondary market transaction data to automotive data processing system 100, one or more information provider systems 160 that provide inventory data to automotive data processing system 100 (referred to herein as inventory systems 160), one or more information provider systems 170 that provide information regarding returned vehicles to automotive data processing system 100 (referred to herein as returned vehicle information systems), and one more information provider systems 172 that provide other types of information to automotive data processing system 100. Network 105 may be, for example, a wireless or wireline communication network such as the Internet or wide area network (WAN), publicly switched telephone network (PTSN) or any other type of communication link.

In accordance with one aspect of the present disclosure, automotive data processing system 100 provides a comprehensive computer system for automating and facilitating a purchase process including financing qualification, inventory selection, document generation and transaction finalization. For example, automotive data processing system 100 may provide an automatic data processing system such as described in United States Patent Publication No. 2018/0204281, entitled “Data Processing System and Method for Transaction Facilitation for Inventory Items,” adapted to incorporate a CVM as described herein. United States Patent Publication No. 2018/0204281 is hereby fully incorporated by reference herein for all purposes.

Automotive data processing system 100 may provide an intermediary site through which vehicles available from multiple dealers are made available to consumers. Using a client application 143 executing on a client computer device 140, a consumer—in this context a “consumer” is any individual, group of individuals, or business entity seeking to purchase in inventory item (e.g., a vehicle or other inventory item) via the system 100—may apply for financing, search dealer inventory, select a vehicle of interest from a dealer and review and execute documents related to the purchase of the vehicle, and execute automated clearing housing (ACH) transactions through automotive data processing system 100 to purchase the vehicle from the dealership. The automotive data processing system 100 may initiate the consumer's fee payments through various payment methods. The inventory items made available for selection by the consumer in the client application may be specifically curated for that user. According to one embodiment, when the consumer is done with a vehicle the consumer returns the vehicle to an approved place. Automotive data processing system 100 may be provided by or behalf of an intermediary that finances the purchase of a vehicle by a consumer from the dealer. In this context.

Automotive data processing system 100 includes data store 120 operable to store obtained data, processed data determined during operation and rules/models that may be applied to obtained data or processed data to generate further processed data. In one embodiment, automotive data processing system 100 maintains secondary market transaction records 122 and inventory records 130. Data store may also maintain other records used to facilitate purchasing of inventory items such as user applications for financing, orders and other records. Further, in the embodiment illustrated, data store 120 is configured to persist rules/models used to analyze secondary market transaction data and inventory data. For example, automotive data processing system 100 maintains transaction processing rules 124, CVM 126, RVM 128, and inventory rules 132. Data store 120 may comprise one or more databases, file systems or other data stores, including distributed data stores managed by automotive data processing system 100.

Turning briefly to various other entities in the topology of FIG. 1, information provider systems provide secondary market transaction data to automotive data processing system. This secondary market transaction data may be consolidated by the information provider system 150 from sources of used vehicle auction transactions across the country. In one embodiment, the transaction data includes, for each vehicle, VIN information (which identifies the make, model and year of the vehicle) as well as the age and mileage of the vehicle. The transaction data also includes the date of sale of the vehicle, the transaction price for the vehicle and other information. Secondary market transaction information may be used to develop a CVM.

Inventory systems 160 may be systems of, for example, dealers (e.g., dealer management systems (DMS)). As will be appreciated dealers may use a DMS to track or otherwise manage sales, finance, parts, service, inventory and back office administration needs. Since many DMS are Active Server Pages (ASP) based, data may be obtained directly from a DMS with a “key” (for example, an ID and Password with set permissions within the) that enables data to be retrieved from the DMS. Many dealers may also have one or more web sites which may be accessed over network 105, where inventory and pricing data may be presented on those web sites. Inventory system 160 may further include, for example, systems of one or more inventory polling companies, inventory management companies or listing aggregators which may obtain and store inventory data from one or more of dealers (for example, obtaining such data from DMSs).

As part of the intake process of a returned vehicle, information about the mileage, condition and location of the vehicle can be collected. To this end, the example topology may therefore include one or more returned vehicle information systems 170 that provide information regarding returned vehicles to automotive data processing system 100, which updates the inventory record for the returned vehicle. At least a portion of the returned vehicles may be routed for disposal (e.g., sold back to the dealer or sold at auction). Thus, when a vehicle is disposed, automotive data processing system 100 will have a record of various vehicle attributes, including the condition of the vehicle, and the secondary market transaction price for the vehicle which was disposed. As discussed further below, this information may be used to develop an adjustment model for adjusting the price output by the CVM.

Automotive data processing system 100 may be coupled to a variety of other information provider systems 172 by network 105, such as systems of entities that provide information used in approving a user or purchase. Examples of other information provider systems may include computer systems controlled by credit bureaus, fraud and ID vendors, vehicle data vendors or financial institutions. A financial institution may be any entity such as a bank, savings and loan, credit union, etc. that provides any type of financial services to a participant involved in the purchase of a vehicle. The information provider systems may comprise any number of other various sources accessible over network 105, which may provide other types of desired data, for example data used in identity verification, fraud detection, credit checks, credit risk predictions, income predictions, affordability determinations, residual value determinations or other processes.

Automotive data processing system 100 may comprise one or more computer systems with central processing units executing instructions embodied on one or more computer readable media where the instructions are configured to perform at least some of the functionality associated with embodiments of the present invention. In the illustrated embodiment, these applications include a model training application 102 and vehicle data application 110. Model training application 102 includes one or more applications (instructions embodied on a computer readable media) configured to implement one or more interfaces 104 utilized by the automotive data processing system 100 to gather data from or provide data to information provider systems 150, client computing devices 142 (e.g., machines of users with permissions to administer or configure automotive data processing system 100). Automotive data processing system 100 utilizes interfaces 104 configured to, for example, receive and respond to queries from users at client computing devices 142, interface with information provider systems 150, 160, 170, 172 to obtain data from or provide data obtained, or determined, by automotive data processing system 100 to client computing devices or information provider systems. It will be understood that the particular interface 104 utilized in a given context may depend on the functionality being implemented by automotive data processing system 100, the type of network 105 utilized to communicate with any particular entity, the type of data to be obtained or presented, the time interval at which data is obtained from the entities, the types of systems utilized at the various entities, etc. Thus, these interfaces may include, for example web pages, web services, a data entry or database application to which data can be entered or otherwise accessed by an operator, APIs, libraries or other type of interface which it is desired to utilize in a particular context.

Model training application 102 comprises a set of processing modules to process obtained data or processed data to generate further processed data. Different combinations of hardware, software, and/or firmware may be provided to enable interconnection between different modules of the system to provide for the obtaining of input information, processing of information and generating outputs. More particularly, model training application 102 comprises model builder 106 that is configured to train machine learning models. According to one embodiment, automotive data processing system 100 may execute model training application 102 to implement a modelling system that supports multiple machine learning algorithms to train models including, but not limited to, generalized linear regression models (linear, logistic, exponential, and other regression models), decision trees (random forest, gradient boosted trees, xgboost), support vector machines and neural networks. In one embodiment, model training application 102 is executable to provide all or a portion of a modelling system as described in United States Patent Publication No. 2019/0042887, entitled “Computer System for Building, Training and Productionizing Machine Learning Models,” which is hereby fully incorporated herein by reference for all purposes.

According to one embodiment, model training application 102 downloads or otherwise receives secondary market transaction data from one or more information provider systems 150. This secondary market transaction data may be consolidated by the information provider system 150 from sources of used vehicle auction transactions across the country. In one embodiment, the transaction data includes, for each vehicle, VIN information (which identifies the make, model and year of the vehicle) as well as the age and mileage of the vehicle. The transaction data also includes the date of sale of the vehicle, the transaction price for the vehicle and other information.

In one embodiment, model training application 102 may receive secondary market transaction data files (such as CSV files) from various sources uploaded to an FTP site. In other embodiments, model training application 102 may collect secondary market transaction information by making appropriate API calls to an information provider system 150. Because different information provider systems may use different data formats, model training application 102 can apply rules to extract transaction information from the various feeds and normalize the data into an internal format. The normalized transaction records may be stored as secondary market transaction records 122. Model training application 102 may also receive data from inventory records 130.

Data from secondary market transaction records 122 and inventory records 130 is input into model builder 106 to train a current value model (CVM) 126 that is configured to output predicted current secondary market transaction prices (current values) for vehicles. Vehicle data application 110, as discussed below, may use CVM 126 and residual value models (RVMs) 128 to filter inventory items, price inventory items, and/or determine payment schedules for inventory items. In some embodiments, automotive data processing system 100 uses RVMs 128 derived from other sources or provided by third-parties. RVMs 128 are maintained for the various different types of vehicles that may be included in the secondary market transaction data.

Vehicle data application 110 comprises one or more applications configured to implement one or more interfaces 112 utilized by the automotive data processing system 100 to gather data from or provide data to client computing devices 140, 141, 142 and information provider systems 160 and other information provider systems. Automotive data processing system 100 utilizes interfaces 112 configured to, for example, receive and respond to queries from users at client computing devices 140, 141, 142, interface with information provider systems 150, 160, 170, 172 to obtain data from or provide data obtained, or determined, by automotive data processing system 100 to client computing devices or information provider systems. It will be understood that the particular interface 112 utilized in a given context may depend on the functionality being implemented by automotive data processing system 100, the type of network 105 utilized to communicate with any particular entity, the type of data to be obtained or presented, the time interval at which data is obtained from the entities, the types of systems utilized at the various entities, etc. Thus, these interfaces may include, for example web pages, web services, a data entry or database application to which data can be entered or otherwise accessed by an operator, APIs, libraries or other type of interface which it is desired to utilize in a particular context.

Vehicle data application 110 can comprise a set of processing modules to process obtained data or processed data to generate further processed data. Different combinations of hardware, software, and/or firmware may be provided to enable interconnection between different modules of the system to provide for the obtaining of input information, processing of information and generating outputs. In the embodiment of FIG. 1, vehicle data application 110 includes a dealer interaction module 114 which can provide a service to allow dealers to register with automotive data processing system 100 to allow vehicles to be purchased through automotive data processing system 100. To onboard a dealer, a dealer account may be established at automotive data processing system 100. Various pieces of information may be associated with the dealer account. Once a dealer is on-boarded, dealer interaction module 114 may provide a dealer portal (e.g., a web site, web service) through which the dealer may access and update information for transactions using, for example, a browser at a dealer client computing device 141. The dealer portal may also include a history of previously completed deals and other information.

As part of onboarding, automotive data processing system 100 can be provided with credentials or other information to allow automotive data processing system 100 to access dealer inventory information from the dealer's DMS an inventory system. In addition, or in the alternative, other channels may be established to retrieve inventory information (e.g., email, FTP upload or other channel).

Inventory module 116 receives inventory feeds from remote sources via the channels established with the dealers, stores inventory records 130, enhances the inventory records with information from other, distributed sources, and applies inventory rules 132 to the inventory records to filter the inventory items down to a program pool of inventory items that have a fair value (in this context, whether an inventory item has a “fair value” is objectively determined based on the rules applied). In accordance with one embodiment, the rules are selected such that each inventory item (e.g., vehicle) in the program pool is priced close to its wholesale value, current market value or other value at the time of sale and can be accurately and competitively priced based on selected metrics.

Inventory rules 132 may further include rules for pricing vehicles based, for example, on CVM 126. Automotive data processing system 100 may use CVM 126 and RVMs 128 to accurately determine an initial payment and monthly (or other periodic) payments for each inventory item.

In some embodiments, system 100 may determine an array of payments for each vehicle, the array containing payments for multiple mileage and credit risk bands. Inventory module 116 stores an inventory record 130 for each vehicle in the vehicle pool, the inventory records containing data obtained from inventory feeds, enhanced data from information provider systems and/or payment schedules. Inventory module 116 can further search inventory records 130 in response to search criteria received from a client computing device 140.

Client computing devices 140, 141, 142 may comprise one or more computer systems with central processing units executing instructions embodied on one or more computer readable media where the instructions are configured to interface with automotive data processing system 100. A client computing device 140, 141, 142 may comprise, for example, a desktop, laptop, smart phone or other device. Client computing devices 142 may run an administrator application that allows an administrative user to perform administration tasks on automotive data processing system, such as configuring model training application 102 and/or vehicle data application 110. Client computing devices 141 represent and a dealer client computing device through which a dealer user can update information for current transactions using, for example, a browser at a dealer client computing device 141. The dealer portal may also include a history of previously completed deals and other information.

Client computing devices 140 represent customer computing devices. A client computing device 140 may run a client application 143, such as a mobile application (“mobile app”) that runs in a mobile operating system (e.g., Android OS, iOS), and is specifically configured to interface with automotive data processing system 100 to generate application pages for display to a user. In another embodiment, the client application 143 may be a web browser on a desktop computer or mobile device.

In accordance with one embodiment, a user can utilize the customer client application to register with automotive data processing system 100, apply for financing, view inventory, select a vehicle, review documents and finalize a sales transaction through a low friction mobile app running on a smart phone. The customer client application can be configured with an interface module to communicate data to/from automotive data processing system 100 and generate a user interface for inputting one or more pieces of information or displaying information received from automotive data processing system 100.

When the customer is done with a vehicle, the customer returns the vehicle to an approved location, which is not necessarily the dealer from which the vehicle was acquired. In one embodiment, the vehicle may be returned to a place associated with an internal dealer for the entity that provides automotive data processing system 100 and ownership may be transferred to (or remain) with that entity. As discussed above, information about the mileage, condition and location of the vehicle can be collected at a returned vehicle information system 170 as part of the intake process for a returned vehicle. Returned vehicle information systems 170 can provide information regarding returned vehicles to automotive data processing system 100, which updates the inventory record for the returned vehicle. At least a portion of the returned vehicles may be routed for disposal (e.g., sold back to the dealer or sold at auction). Thus, when a vehicle is disposed, automotive data processing system 100 will have a record of various vehicle attributes, including the condition of the vehicle, and the secondary market transaction price for the vehicle which was disposed. As discussed further below, this information may be used to develop an adjustment model for adjusting the price output by the CVM.

It should be noted here that not all of the various entities depicted in the topology are necessary, or even desired, in embodiments of the present invention, and that certain of the functionality described with respect to the entities depicted FIG. 1 may be combined into a single entity or eliminated altogether. Additionally, in some embodiments other data sources not shown in FIG. 1 may be utilized. FIG. 1 is therefore exemplary only and should in no way be taken as imposing any limitations on embodiments of the present invention.

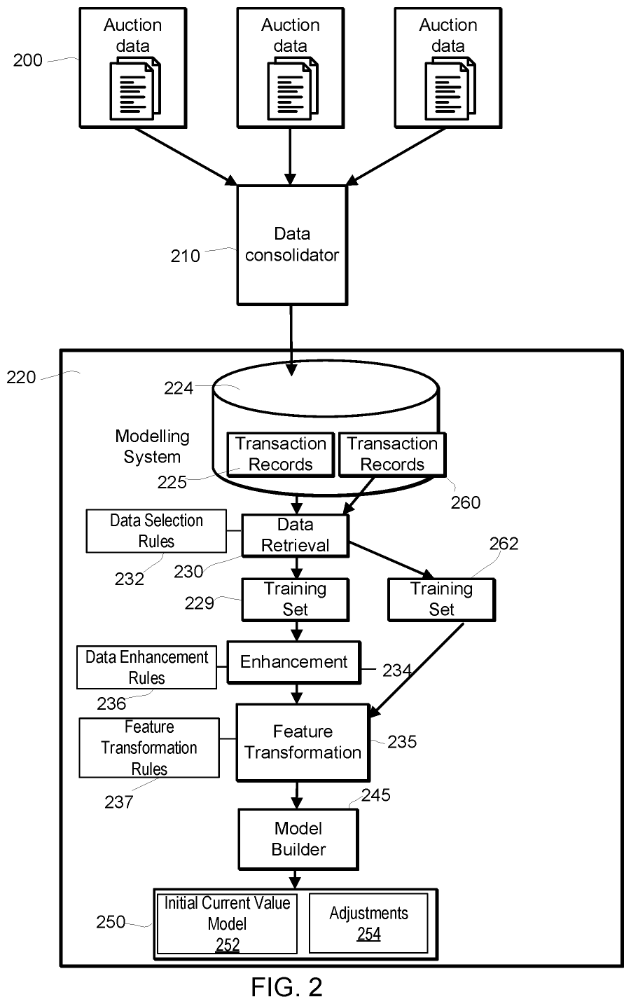

FIG. 2 illustrates one embodiment of a modelling system 220 training a CVM 250. According to one embodiment, modelling system 220 is provided by automotive data processing system 100 executing model training application 102 to build CVM 126.

According to one embodiment, CVM 250 includes a first machine-learning model 252 trained on a set of secondary market transaction data to predict a current secondary market transaction price and adjustments 254 used to adjust the output of the first machine-learning model. According to one embodiment, adjustments 254 comprise an auxiliary model or data derived from the auxiliary model used to adjust the output of model 252. It can be noted that, in some embodiments, model 252 and the auxiliary model may be trained using different secondary market transaction records.

According to one embodiment, secondary market transaction data is uploaded from one or more data sources 200 to a data consolidator 210. The consolidated secondary market transaction data can then be downloaded to the modelling system 220 by FTP or other mechanism. As will be appreciated, secondary market transaction data can be acquired (e.g., via API, file download or other mechanism) from various providers including, but not limited to the National Association of Auto Dealers (NADA) of Tysons, Va., and Aucnet, Inc. of Japan. The downloaded secondary market transaction data is stored in a data storage 224 for processing.

A secondary market transaction data feed record for a secondary market transaction can include various information. In one embodiment, each secondary market transaction feed record can include the secondary market transaction price, sales date, where the vehicle was sold and vehicle characteristic information for the specific vehicle corresponding to the transaction. In some embodiments, each secondary market transaction data feed record includes a VIN10 or VIN17. The VIN10 for a vehicle is the first 10 digits of the Vehicle Identification Number (VIN), which identifies such things as the manufacturer, model, body type, model year, trim, engine displacement, drive type (two-wheel drive or four-wheel drive), and in some cases transmission type (automatic or manual). The remainder of the VIN (digits 11-17) contains a serial number that can be used to identify the specific vehicle associated with the transaction record. In some embodiments, the VIN data included in the secondary market transaction only includes the VIN10 portion of the VIN. The secondary market transaction data feed record may include additional information that identifies information that might not be obtained from the VIN10, such as series lifecycle, vehicle condition (rough, poor, average, good, excellent condition), geographical region, type of sale, options, color, fuel type, remaining OEM or CPO warranty coverage, odometer reading, a description of the vehicle, or the like. Different information provider systems may use different data formats and modelling system 220 can be configured with rules to extract information from various feeds. Modelling system 220 further normalizes secondary market transaction data feed records into an internal format to store secondary market transaction records 225 (e.g., secondary market transaction records 122) used to train initial current value model 252.

Modelling system 220 includes a data selection module 230 configured with data selection rules 232. According to one embodiment, data selection rules 232 may be selected to filter out records based on for example, vehicle characteristics (e.g., to filter out rare or unusual vehicles), time period or other criteria to determine a training set 229 of secondary market transaction records, which may include a large number (e.g., millions) of records. As will be appreciated, a portion of the training set 229 may be used for training and another portion used for validation. The first machine learning model 252 and any auxiliary models may be refined through validation and iteration as will be appreciated by those in the art.

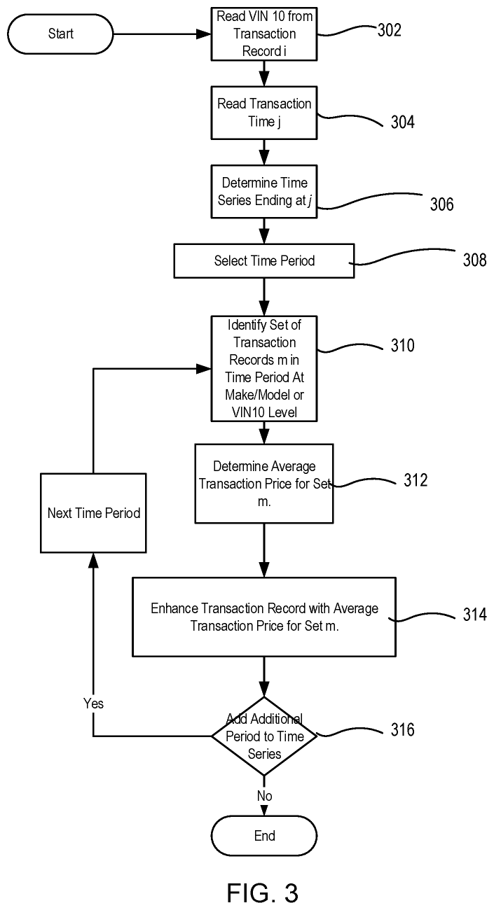

According to one embodiment, secondary market transaction records 225 are enhanced by an enhancement module 234 that applies data enhancement rules 236. The secondary market transaction records may be enhanced by data from other sources or otherwise enhanced. According to one embodiment, enhancement module 234 enhances transaction records with transaction price trend data, such as a VIN10 level price trend or other transaction price time series. One embodiment of enhancing a transaction record with trend data is illustrated in FIG. 3, which provides a flow chart of one embodiment. Enhancement module 234 is configured with a time series parameter, such as a time period and number of periods to consider. For a selected secondary market transaction record i, enhancement module 234 reads VIN (e.g., the VIN10 (step 302) the transaction date j (step 304) from the record i being processed. Enhancement module 234 determines a time series of the average secondary market transaction prices for that VIN10 or make/model for the number of periods.

For example, if enhancement module 234 is configured to create a time series with a granularity of 1 week for a 5 week period, enhancement module 234 selects the series of five one week periods ending at j (step 306), selects a time period in the series (e.g., selects a week from the five weeks) (step 308), determines, for the time period, the set m of secondary transaction records (e.g., in training set 229) for the same make/model (or VIN10) (step 310), determines the average transaction price for make/model (or VIN10) for the corresponding one-week period (step 312) and enhances record i with average transaction price for set m (step 314). As illustrated by step 316, enhancement module 234 can repeat steps 310-314 for each time period determined at step 306 to enhance the secondary transaction record i with the time series of average transaction prices for the make/model or VIN10. This process can be repeated for each secondary market transaction record 225 or each secondary market transaction record in training set 229 to enhance each such record with the corresponding transaction price trend data. FIG. 3 is merely an illustrative example and the disclosed subject matter is not limited to the ordering of or number of steps illustrated. Embodiments may implement additional steps or alternative steps, omit steps, or repeat steps.

Continuing with FIG. 2, a secondary market transaction record in training set 229 may include a variety of information such as secondary market transaction price, transaction date, price trend data, geographic region sale took place, mileage, make, model, body type, model year, trim, vehicle segment, engine displacement, drive type (two wheel drive, four wheel drive), transmission type, fuel type, series life cycle, vehicle condition, options, color, remaining OEM or CPO warranty coverage, and/or other information.

Secondary market transaction records (e.g., secondary market transaction records in training set 229) are processed by a feature transformation module 235 that applies feature transformation rules 237 to transform data in each selected record 225 into features on which the model is to be trained. By way of example, but not limitation, feature transformation module 235 may map various characteristics of vehicles to dummy variables or other numeric data, apply feature scaling, bin records into various categories. Non-limiting examples of feature transformations include:

Encoding categorical features (“one-hot-encoding”). In one embodiment, one hot encoding is applied to model name as a dummy variable. In various embodiments one hot encoding is applied to various other categorical features such as trim name, region, or other categorical features.

Binning records into model, vin10, make or segment level bins, binning records based on color or trim. Binning may be performed to group records for determining price trends. Price trends, as discussed above, can be determined at the bin level. Thus, in some cases, one or more transformations may be applied prior to one or more data enrichments.

According to one embodiment, each secondary market transaction record in training set 229 is transformed into a feature vector comprising features representing secondary market transaction price, vehicle age, vehicle make, vehicle model, and mileage (raw mileage or mileage band). The feature vector may further comprise features for one or more of price trend data, region, color, trim, body type, fuel type and drive type, transmission type, engine displacement, vehicle segment, remaining OEM warranty, remaining CPO warranty or other features for a vehicle. The feature vector may also include features representing other sales information, vehicle information, usage information or industry information. In a particular example, the feature vector includes features for the vehicle attributes of make/model, trim, age, mileage, exterior color, body type, fuel type, drive type, and VIN10 level price trend data, with the secondary market transaction price being the dependent variable. The feature vector may also represent for example seasonality.

The transformed secondary market transaction records are ingested by a model builder 245 configured to train a machine learning model 252. By way of example, but not limitation, model builder 245 may be configured to train a generalized linear regression model (linear, logistic, exponential, and other regression models), decision tree (random forest, gradient boosted trees, xgboost), vector machine, neural network or other machine learning models. According to one embodiment, model builder 245 trains a LightGBM Gradient Boosted Tree model. One example of the LightGBM Gradient Boosted Tree algorithm is described in LightGBM: A Highly Efficient Gradient Boosting Decision Tree, by Ke et al. 31^{st} Conference on Neural Information Processing Systems (NIPS 2017), Long Beach, Calif., USA, which is hereby fully incorporated by reference herein. Such model may be trained using the LightGBM gradient boosting framework from Microsoft Corporation.

The LightGBM model is trained to determine vehicle price by fitting a large number of trees, (e.g., hundreds of decision trees) and combining their predictions. Each tree is a large set of if/then decisions which minimize prediction error based on vehicle attributes and corresponding secondary market transaction prices. Training the model can include tuning various parameters including boosting_type, num_iterations, learning_rate, num_leaves, min_child_samples, feature_fraction to a achieve a model with acceptable accuracy. Other parameters of the LightGBM algorithm may also be tuned.

CVM 250 may thus comprise a first machine-learning model 252, where the first machine learning model is a LightGBM model, or other machine learning model, that represents a plurality of vehicle features and is configured output a prediction of secondary market transaction price—an initial prediction or final prediction, depending on the model—that is vehicle specific. According to one embodiment, the input information for a specific vehicle then may include, for example, make/model, trim, age, mileage, exterior color, body type, fuel type, drive type, and VIN10 level price trend data. In some embodiments, the input information for a vehicle may further include transmission type, engine displacement, segment, remaining OEM warranty, remaining CPO, condition, seasonality or other information.

In some embodiments, the first machine-learning model 252 of CVM 250 does not account for certain factors that may influence transaction price. CVM 250 may comprise further adjustments 254 to the output of the first machine-learning model 252. For example, in one embodiment, the first machine-learning model 252 of CVM 250 represents features for make/model, trim, age, mileage, exterior color, body type, fuel type, drive type, and VIN10 level price trend data and produces an initial prediction of current value that is vehicle, but not condition specific.

To account for condition, CVM 250 may include condition adjustments (e.g., adjustments 254). According to one embodiment, historical price distributions are determined based on secondary market transaction data and an adjustment coefficient derived for each condition grade (e.g. rough, poor, average, good, excellent condition). The specific coefficients can be derived using an auxiliary model that is configured to model relationship between condition grade and transaction sale price.

As discussed above, secondary market transaction data received from a 3^{rd} party can include vehicle condition (rough, poor, average, good, excellent condition) or the automotive data processing system can track the condition and secondary market transaction prices for vehicles returned by customers. Thus, a set of transaction records 260 may be used to train an auxiliary model. Transaction records 260 may represent secondary market transaction records or inventory records for vehicles returned by customers where the transaction records 260 include condition information and a secondary market transaction price. Such records may include for example make/model (or VIN10), mileage and other information for a vehicle. In one embodiment then, data retrieval module can select a training set 262 of transaction records which can be transformed into features representing make/model, year, mileage (raw mileage or mileage band), condition and secondary market transaction price. Secondary market transaction records (e.g., secondary market transaction records in training set 262) are processed by a feature transformation module 235 that applies feature transformation rules 237 to transform data in each selected record 225 into features on which the model is to be trained. By way of example, but not limitation, feature transformation module 235 may map various characteristics of vehicles to dummy variables or other numeric data, apply feature scaling, bin records into various categories.

Model builder 245 trains an auxiliary model to quantify the functional relationship between secondary market transaction price and condition grade. According to one embodiment, the auxiliary model may be a regression model, such as a linear regression model, the models the adjustment to secondary market transaction value by condition grade by, for example, make/model/year. From the auxiliary model, adjustment coefficients can be derived for each condition grade. CVM 250 can include the auxiliary model and/or adjustment coefficients.

According to one embodiment, the trained CVM 250, including the trained first machine learning model 252 and auxiliary model (or adjustments derived from the auxiliary model), may be output as a model comprising a set of software objects with methods to implement the model on data input model. According to one embodiment, the trained models may be models according to an Adaptive Modelling Language (AML) that comprise AML objects. A trained model may include methods to implement the data pipeline used to train the model—the data source pipeline and/or additional transformations used during training. For example, CVM 250 can include a pipeline to enhance and transform data as applied by enhancement module 234 and feature transformation module 235. Each trained model may further comprise a commonly named prediction function used to initiate a prediction of current value by the model. The function of the CVM 250 may be callable to take input in the model input format and return a current value. The trained model can process the input data using the pipeline, apply the model and generate the current value.

It can be noted that a trained CVM 250 can be directly deployable as a production model. According to one embodiment, CVM 250 can be registered with a server that provides a web framework with an API through which functions of CVM 250 may be called. According to one embodiment, the selected model can be called to request a prediction of current value.

In some embodiments, the model training input format used to train CVM 250 (e.g., to train first machine learning model 252—for example, and initial CVM model—and the auxiliary model is selected to match the production format such that the CVM 250 can receive the production formatted data when the functions of CVM 250 are called and apply the same pipeline(s) as was used in training the model.

For vehicles that are to be made available in one or more program pools, the CVM 250 outputs a predicted current value, which can then be used in determining a fair payment schedule for the vehicle. According to one embodiment, the CVM 250 uses a set of vehicle attributes (e.g., Make, Model, Trim, Age, Mileage, Exterior Color, Body Type, Fuel Type, Drive Type, VIN10 level price trends) to determine an initial prediction of current value and applies a condition adjustment (or other adjustments) to output a final prediction of current value.

The predicted current value for a vehicle output by the CVM 250 can be input into a residual value model from a plurality of residual value models. Each RVM can correspond to a year/make/model/trim and mileage band. For example, for a specific year/make/model/trim, automotive data processing system 100 can determine or be configured with a 10,000 mile-a-year depreciation curve, a 12,500 mile-per-year curve, etc., up to a maximum mileage band supported by the system 100. Each RVM may be a decay model that applies a rate of decay to a starting point. The output of the CVM 250 can be used as the starting point (i.e., vehicle residual value at month 0) for predicting future values of the vehicle using an RVM.

The CVM 250 can be periodically retrained on new data from a third-party provider or internal data collected by automotive data processing system 100 over time. As such, the residual value determination may thus become increasingly accurate with additional data. The CVM 250 may contextualize data analysis. For example, one piece of information (or combination thereof) may be analyzed differently depending on the results of analyzing another piece of information (or combination thereof).

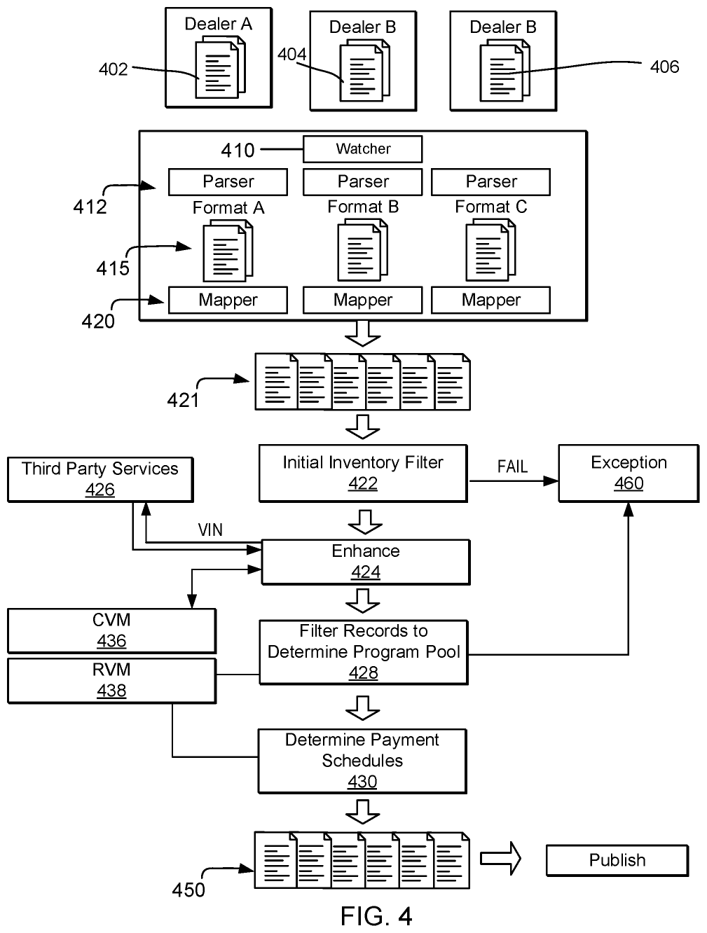

FIG. 4 is a block diagram illustrating one embodiment of inventory processing that may be performed by automotive data processing system 100. According to one embodiment, inventory module 116 may perform inventory processing. Automotive data processing system 100 receives inventory feeds from inventory systems (e.g., DMS, inventory polling systems or via other channels). According to one embodiment, automotive data processing system 100 may receive inventory files (such as CSV files) from various dealers uploaded to an FTP site. In other embodiments, automotive data processing system may collect inventory information by making appropriate API calls to a DMS or other inventory system.

The inventory feeds include inventory data for inventory associated with registered (on-boarded) dealers and pricing information. Different dealers or DMS systems, however, may use different data formats. Automotive data processing system 100 can apply rules to extract inventory information from the various feeds and normalize the data into an internal format.

The record for a vehicle in an inventory feed may include information from one or more sources, can include information such as a VIN, segment, manufacturer, model, model year, trim level, engine displacement, drive type, series lifecycle, vehicle condition (e.g., rough, poor, average, good, excellent condition), geographical region, type of sale, options, color, remaining OEM or CPO warranty coverage, dealer asking price, dealer odometer reading, dealer description of the vehicle. It may be noted that, in some cases, an inventory feed record may only provide a limited amount of information, such as VIN, year/make/model, dealer odometer reading, dealer asking price. In some cases, an inventory feed may include updates for existing inventory records. As discussed below, the inventory data from an inventory feed may be enhanced with data from other network locations.

Different dealers or DMS systems may use different data formats. Automotive data processing system 100 can apply rules to extract inventory information from the various feeds and normalize the data into an internal format. For each VIN, the automotive data processing system 100 can create a normalized inventory record.

In the illustrated example, dealer A uploads inventory files 402 in a first format to a first FTP site, dealer B provides inventory files 404 in a second format to a second FTP site and dealer C uploads inventory files 406 in a third format to a third FTP site. According to one embodiment, automotive data processing system 100 can comprise a watcher process 410 that watches for new inventory feed events, such as a file being uploaded to an FTP site, and initiates a processing job to process the records in the inventory feed. Thus, processing jobs can begin as soon as an inventory file is uploaded.

Based on watcher process 410 determining that a new inventory file has been uploaded or an inventory feed otherwise received, vehicle data application 110 can read and process the feed. According to one embodiment, vehicle data application 110 can be configured to parse the CSV files (or other input data) to extract records for individual vehicles. Therefore, vehicle data application 110 may include parsers 412 dedicated to each input format and configured to parse out individual inventory feed records 415 from inventory files. Moreover, vehicle data application 110 can include format mapping modules 420 configured to map extracted records from different dealer formats into inventory records in a normalized internal format. For example, each mapping module may be configured to extract delimited data from CSV records and map the delimited data to normalized fields to create or update normalized inventory records 421.

Vehicle data application 110 may apply initial inventory filter rules 422. Initial inventory filter rules 422 may include rules to filter out records based on a variety of factors. An initial set of filters may filter out inventory records with incomplete or duplicative data or based on other criteria. For example, rules may be applied to filter out vehicles for which the asking price is above a particular maximum price, vehicles outside of particular geographic regions, new vehicles or based on other criteria. Filtering rules may filter out vehicles based on maximum age and mileage thresholds. Different age and mileage caps may be set for different vehicles depending on, for example, the reliability of the vehicle year/make/model, remaining warranty or other factors.

For inventory records that are not filtered out at 422, automotive data processing system 100 can pass the inventory record for further processing. If an inventory record for the VIN exists in system 100 already, automotive data processing system can update the inventory record for the vehicle and pass the updated record for further processing.

At block 424, the automotive data processing system 100 enhances inventory records. According to one embodiment, automotive data processing system 100 interfaces with one or more distributed information provider systems 172 to enhance the inventory record. For example, automotive data processing system 100 may use APIs to collect relevant data from a number of third-party services 426. Note that each API call may be associated with a staleness check. A particular set of enhanced inventory data is not collected again for a vehicle unless the data is considered stale. When enhanced inventory data is collected for a VIN, the inventory record for a VIN may be updated with the date at which data was collected from the particular third-party service 426.

According to one embodiment, automotive data processing system 100 can send a VIN (and some cases additional data) to one or more automotive description services which may be provided by information provider systems 172, receive information associated with each VIN in response and enhance the inventory record for the VIN based on the received information. For each VIN in an inventory feed, automotive data processing system 100 can check when description service data from the automotive description service information provider was last checked (if ever) for that VIN and if the information for that VIN is not stale (e.g., was checked within the last x days by automotive data processing system 100), request the description information from the automotive description service. Automotive description services can provide information such as year, make, model, trim, style, color, technical specifications, standard equipment, installed options for a VIN, stock images for the make/model/trim and other information. One example of an automotive description service is the ChromeData service provided by Autodata, Inc. of Portland, Oreg.

Automotive data processing system 100 can further enhance an inventory record with vehicle history data. According to one embodiment, automotive data processing system 100 may obtain vehicle history reports from a vehicle history information system (which can be an example of an information provider system 172). For example, Carfax, Inc. of Centerville, Va. provides a vehicle history reporting service. As another example, Experian provides the Autocheck vehicle history report service. For each VIN in an inventory feed, automotive data processing system 100 can check when vehicle history data from the vehicle history reporting service was last checked (if ever) for that VIN and if the information for that VIN is not stale (e.g., was checked within the last y days by automotive data processing system 100), request the vehicle history information system.

Automotive data processing system 100 may enhance a vehicle inventory record with price trend data, for example price trend data for the make/model or VIN10. For example, price trend data for a vehicle may be determined as described, for example, in FIG. 3 using historical secondary market transaction records for the make/model or VIN10.

Automotive data processing system 100 can further enhance a vehicle inventory record with a current value. According to one embodiment, automotive data processing system 100 is configured with a CVM 436 (e.g., CVM 126, 250) that is configured to output a prediction of current value based on vehicle attributes such as, but not limited to make, model, age, price trend (e.g., price trend data for make/model or VIN 10), mileage (raw or mileage band), region, color, trim, body type, fuel type, vehicle segment, transmission type, engine displacement, remaining OEM warranty, remaining CPO warranty or other features of a vehicle. For example, CVM 436 is configured to determine a current value based on, for example, make/model, trim, age, mileage, exterior color, body type, fuel type, drive type, price trend data and condition.

According to one embodiment, CVM 436 includes a machine learning model that uses a set of vehicle attributes (for example, but not limited to, model, trim, age, mileage, exterior color, body type, fuel type, drive type, VIN10 level price trends) to determine an initial prediction of current value for a vehicle or type of vehicle and applies a condition adjustment (or other adjustments) to the output of the first machine learning model to output a final prediction of current value for inventory vehicles. The adjustments can include an auxiliary machine learning model, adjustments derived from an auxiliary machine learning model or other adjustments. As one example, CVM 436 can include a set of condition adjustment coefficients derived for each condition grade of a set of condition grades (e.g. rough, poor, average, good, excellent condition).

According to one embodiment, automotive data processing system 100 transforms data from a vehicle inventory records or other sources into features and processes the features using CVM 436 to predict a current value for the vehicle. By way of example, but not limitation, automotive data processing system 100 may transform data from an inventory record into features representing model, trim, age, mileage, exterior color, body type, fuel type, drive type, VIN10 level price trends. As discussed above, the pipeline for transforming data may be encapsulated in CVM 436.

Automotive data processing system 100 processes at least a subset of the features using the first machine-learning model of CVM 436 to determine an initial predicted secondary market transaction price for the vehicle and apply adjustments—for example, apply an adjustment coefficient appropriate for the condition grade of the vehicle—to determine a final predicted secondary market transaction price for the vehicle. CVM 436, according to one embodiment, outputs the final predicted secondary market transaction price as the current value for the vehicle and automotive data processing system 100 enhances the vehicle inventory record with the final current value.

Based on the enhanced inventory records, automotive data processing system 100 can further filter vehicles at 1338 to determine vehicles in the program pool. Examples of additional fair value filters that can be applied include, by way of example:

Based on the enhanced inventory records, automotive data processing system 100 can further filter vehicles at bock 428 to determine vehicles in include in a program pool. Examples of additional fair value filters that can be applied include, by way of example:

Make/Model/trim: Automotive data processing system 100 can filter out a vehicle if there is insufficient data to match the vehicle to a pre-determined residual value model. Automotive data processing system 100 can determine if it has an RVM 438 corresponding to the year/make/model/trim of vehicle represented in an inventory record and filter out the feed record if automotive data processing system 100 does not have the appropriate residual value model.

Vehicle history: Vehicles may be filtered based on vehicle history. Rules can be applied to the vehicle history information to exclude vehicles. Rules may be established to exclude vehicles based on, for example, accidents, airbag deployment, structural damage, branded title or other title marks, odometer info or other items.

Price: In some embodiments, vehicles can be filtered based on price. An entity may only wish to offer vehicles that are priced near fair market value at sale. As such, rules may be established to filter out vehicles that, according to the rules, are over-priced. Price filtering may be based, for example, on current value determined by the CVM 436. In one embodiment, for example, automotive data processing system may filter out vehicles that exceed the predicted current value by a specified dollar or percentage cap. For example, a rule can be established such the vehicles must be priced within a set % cap (e.g., 110-120% or other percentage) or dollar value of the final current value for that vehicle output by CVM 436. The price filter helps ensure that each vehicle is priced close to the predicted current value for that vehicle. In addition, a price filter may be applied to filter out vehicles that are priced too low compared the final current value.

In some embodiments, there may be multiple program pools to which a vehicle can be routed (e.g., general consumer, ride share, rental). The filters applied may be used to route vehicles to an appropriate program pool or reject vehicles. For example, mileage, age, price or other filters may applied to determine the program pool to which a vehicle is to be routed.

In accordance with one embodiment, records that do not meet the filter criteria applied at 422 and 428 can be added to a queue of exceptions 460. A number of the above-referenced filters may be applied to pre-filter inventory before accepting the inventory into the system or before displaying an inventory item to a consumer. Additional filters may also be applied to post-filter inventory records after inventory records have entered the system. For example, in one embodiment, automotive data processing system 100 may obtain a more detailed vehicle history report when a user selects a particular vehicle and filter the vehicle based on the additional vehicle history report information.

According to one embodiment then, the inventory records 450 can include inventory records for a program pool where the inventory records passed the pre-filters and have not been eliminated by a post-filter and, in some cases, inventory records that passed all the pre-filters except price and have not been eliminated by a post-filter. These inventory feed records may be used to determine qualified vehicles for consumers.

The predicted current value determined for a vehicle (e.g., the final current value output by CVM 436) may be used in pricing a vehicle. For example, automotive data processing system 100 can offer the vehicle for purchase at the final current value or some percentage or offset above current value. In another embodiment, the final current value may be used in determining payment schedules. More particularly, in one embodiment, at block 430, automotive data processing system 100 is configured to apply RVMs 438 to determine initial and monthly payments for vehicles in a program pool where the payments are selected to achieve desired metrics.

As discussed above, CVM 436 is configured to output a prediction of current values for inventory vehicles. A residual value model (RVM 438) for the vehicle type can be applied to the predicted current value to predict the asset value of inventory vehicles at each term t. Each RVM 438 can correspond to a vehicle type (e.g., year/make/model/trim, VIN10 or other definition of vehicle type) and mileage band. For example, for a specific year/make/model/trim, automotive data processing system 100 can determine or be configured with a 10,000 mile-a-year depreciation curve, a 12,500 mile-per-year curve, etc., up to a maximum mileage band supported by the system. In one embodiment, each RVM is a decay model that applies a rate of decay to a starting point. The output of the CVM 436 can be used as the starting point (i.e., vehicle residual value at month 0) for predicting future values of the vehicle using an RVM 438. Thus, the current value output by CVM 436 and the appropriate RVMs 438 can be used to predict the residual value of a vehicle at the end of each term for each mileage band.

In one embodiment, the predicted current value and predicted future residual values can be used to determine a payment schedule for a vehicle. One embodiment of determining a payment schedule is described in United States Patent Publication No. 2018/0204173, entitled “Data Processing System and Method for Rules/Machine Learning Model-Based Screening of Inventory,” filed Jan. 17, 2018, which is hereby fully incorporated by reference herein for all purposes.

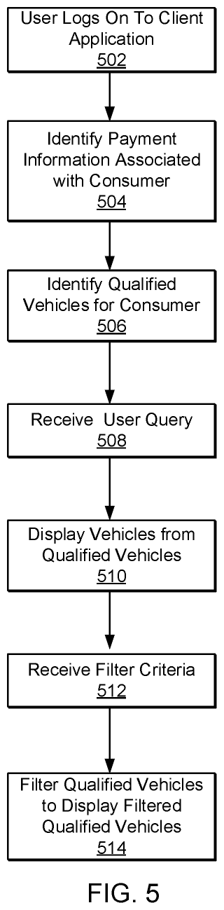

FIG. 5 is a flow chart illustrating one embodiment of returning qualified vehicles for browsing to a user. As depicted in this figure, a consumer first logs onto a client application which interacts with the vehicle data application 110 (step 502). Vehicle data application 110 identifies payment information associated with the consumer (step 504). In general, the payment information for a consumer represents a periodic payment (e.g., monthly payment) that a consumer or type of consumer (consumers fitting a consumer profile) will be willing to pay or is predicted to be willing to pay. In some embodiments, the payment information may indicate a payment regardless of vehicle type (e.g., consumer is associated with a payment of $400). In other embodiments, the payment information may specify payments for specific vehicle types (e.g., the consumer is associated with a payment of $400 for vehicle type 1 and $450 for vehicle type 2, etc.). In some embodiments, the payment information may be determined based on an affordability score, such as described in United States Patent Publication No. 2018/0204173, entitled “Data Processing System and Method for Rules/Machine Learning Model-Based Screening of Inventory.” In other embodiments, the payment information is input by the consumer (i.e., the consumer indicates a monthly amount they are willing to pay to pay). Other mechanisms for determining payment information associated with a consumer may also be used.

At step 506, vehicle data application 110 identifies inventory items that the consumer is qualified to purchase (buy, lease or subscribe to) based on the payment information associated with the consumer and the current values determined for the items by the CVM. For example, vehicle data application 110 identifies a qualified vehicle based on payment information associated with the vehicle where the payment information associated with a vehicle is determined based on the current value predicted by a CVM (e.g., CVM 126, CVM 250, CVM 436). In one embodiment, for example, the data processing system identifies the eligible inventory items as those items having a payment schedule with a monthly payment that is less than the payment the consumer is willing (predicted to be willing) to make for that vehicle type, where the monthly payment schedule is determined based on applying an RVM to the current value output for vehicle by the CVM to determine the monthly payments needed to achieve desired ROA metrics. Thus, a vehicle may be considered a qualified vehicle for the consumer based on the current value determined by the CVM. The consumer may provide consumer filter parameters to filter the set of eligible inventory items by various factors.

At step 508, vehicle data application 110 receives a query from the consumer to browse qualified vehicles and, at step 510, can return a list of qualified vehicles to the consumer for display in the in the client application, The data processing system can receive the filter parameters (step 512), search the inventory records of the qualified vehicles and return inventory record data for the inventory items meeting the filter criteria (step 514) for display in the client application. In some embodiments, the consumer may select and purchase a qualified vehicle via the automotive data system. Because the vehicles that are displayed to the consumer responsive to these queries or in the course of browsing are selected from the qualified vehicles that were previously identified by the vehicle data application, it is assured that any transaction completed by the consumer will provide the return desired by the system operator.

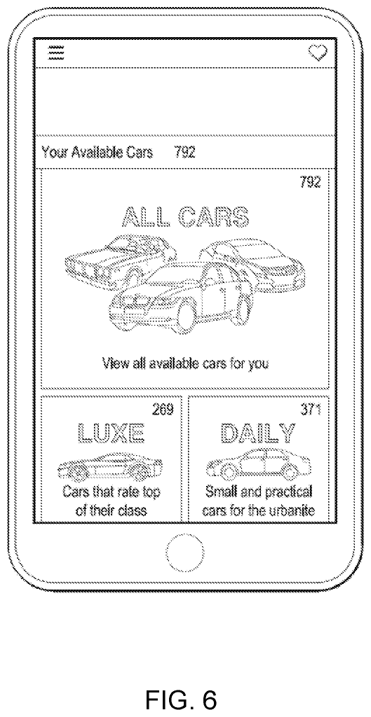

FIG. 6 illustrates one embodiment of a user interface in a client mobile device, which may be one example of a client computing device 140. In this example, a consumer is using a client application to interact with a vehicle data system that includes a large number (e.g., thousands, hundreds of thousands) of available inventory items. Because of the payment information associated with the consumer, however, the consumer is only provided access to 792 qualified vehicles. The vehicles may be grouped or categorized for display.

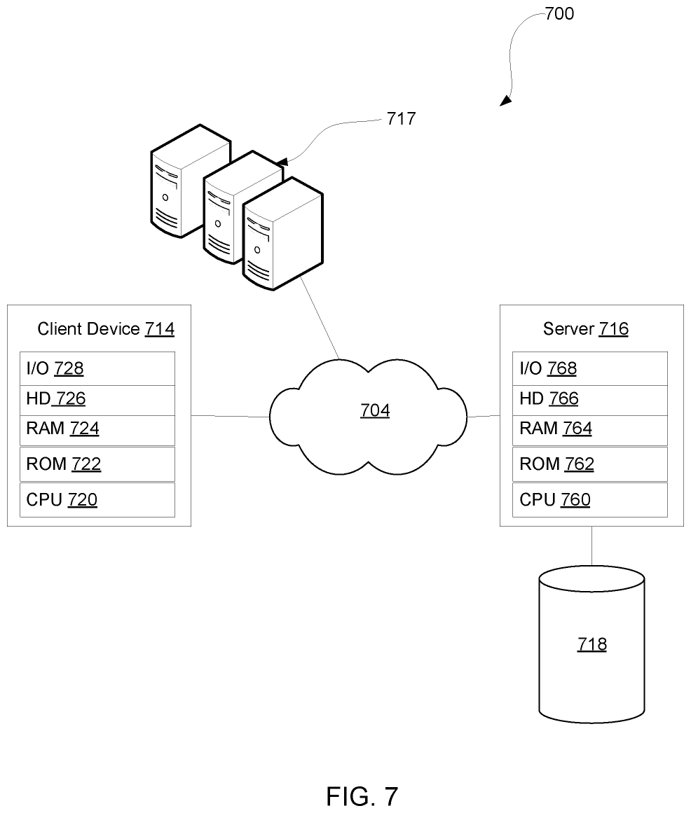

FIG. 7 depicts a diagrammatic representation of a distributed network computing environment where embodiments disclosed can be implemented. In the example illustrated, network computing environment 700 includes network 704 that can be bi-directionally coupled to a client computing device 714, a server system 716 and one or more third party systems 717. Server system 716 can be bi-directionally coupled to data store 718. Network 704 may represent a combination of wired and wireless networks that network computing environment 700 may utilize for various types of network communications known to those skilled in the art.

For the purpose of illustration, a single system is shown for each of client computing device 714 and server system 716. However, a plurality of computers may be interconnected to each other over network 704. For example, a plurality of client computing devices 714 and server systems 716 may be coupled to network 704.

Client computer device 714 can include central processing unit (“CPU”) 720, read-only memory (“ROM”) 722, random access memory (“RAM”) 724, hard drive (“HD”) or storage memory 726, and input/output device(s) (“I/O”) 728. I/O 728 can include a keyboard, monitor, printer, electronic pointing device (e.g., mouse, trackball, stylus, etc.), or the like. In one embodiment I/O 728 comprises a touch screen interface and a virtual keyboard. Client computer device 714 may implement software instructions to provide a client application configured to communicate with an automotive data processing system. Client computer device depicts one embodiment of a client computer device 140, 141, 142. Likewise, server system 716 may include CPU 760, ROM 762, RAM 764, HD 766, and I/O 768. Server system 716 may implement software instructions to implement a variety of services for an automotive data processing system. These services may utilize data stored in data store 718 and obtain data from third party systems 717. Many other alternative configurations are possible and known to skilled artisans.

Each of the computers in FIG. 7 may have more than one CPU, ROM, RAM, HD, I/O, or other hardware components. For the sake of brevity, each computer is illustrated as having one of each of the hardware components, even if more than one is used. Each of computers 714 and 716 is an example of a data processing system. ROM 722 and 762; RAM 724 and 764; storage memory 726, and 766; and data store 718 can include media that can be read by CPU 720 or 760. Therefore, these types of memories include non-transitory computer-readable storage media. These memories may be internal or external to computers 714 or 716.

ROM, RAM, and HD are computer memories for storing computer-executable instructions executable by the CPU or capable of being compiled or interpreted to be executable by the CPU. Suitable computer-executable instructions may reside on a computer readable medium (e.g., ROM, RAM, and/or HD), hardware circuitry or the like, or any combination thereof. Within this disclosure, the term “computer readable medium” is not limited to ROM, RAM, and HD and can include any type of data storage medium that can be read by a processor. Examples of computer-readable storage media can include, but are not limited to, volatile and non-volatile computer memories and storage devices such as random access memories, read-only memories, hard drives, data cartridges, direct access storage device arrays, magnetic tapes, floppy diskettes, flash memory drives, optical data storage devices, compact-disc read-only memories, and other appropriate computer memories and data storage devices. Thus, a computer-readable medium may refer to a data cartridge, a data backup magnetic tape, a floppy diskette, a flash memory drive, an optical data storage drive, a CD-ROM, ROM, RAM, HD, or the like.

Those skilled in the relevant art will appreciate that the embodiments can be implemented or practiced in a variety of computer system configurations including, without limitation, multi-processor systems, network devices, mini-computers, mainframe computers, data processors, and the like. Embodiments can be employed in distributed computing environments, where tasks or modules are performed by remote processing devices, which are linked through a communications network such as a LAN, WAN, and/or the Internet. In a distributed computing environment, program modules or subroutines may be located in both local and remote memory storage devices. These program modules or subroutines may, for example, be stored or distributed on computer-readable media, stored as firmware in chips, as well as distributed electronically over the Internet or over other networks (including wireless networks). Example chips may include Electrically Erasable Programmable Read-Only Memory (EEPROM) chips.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention. Steps, operations, methods, routines or portions thereof described herein be implemented using a variety of hardware, such as CPUs, application specific integrated circuits, programmable logic devices, field programmable gate arrays, optical, chemical, biological, quantum or nanoengineered systems, or other mechanisms.

Software instructions in the form of computer-readable program code may be stored, in whole or in part, temporarily or permanently, on a non-transitory computer readable medium. The computer-readable program code can be operated on by a processor to perform steps, operations, methods, routines or portions thereof described herein. A “computer-readable medium” is a medium capable of storing data in a format readable by a computer and can include any type of data storage medium that can be read by a processor. Examples of non-transitory computer-readable media can include, but are not limited to, volatile and non-volatile computer memories, such as RAM, ROM, hard drives, solid state drives, data cartridges, magnetic tapes, floppy diskettes, flash memory drives, optical data storage devices, compact-disc read-only memories. In some embodiments, computer-readable instructions or data may reside in a data array, such as a direct attach array or other array. The computer-readable instructions may be executable by a processor to implement embodiments of the technology or portions thereof.

A “processor” includes any, hardware system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

Different programming techniques can be employed such as procedural or object oriented. Any suitable programming language can be used to implement the routines, methods or programs of embodiments of the invention described herein. Communications between computers implementing embodiments can be accomplished using any electronic, optical, radio frequency signals, or other suitable methods and tools of communication in compliance with known network protocols.

Any particular routine can execute on a single computer processing device or multiple computer processing devices, a single computer processor or multiple computer processors. Data may be stored in a single storage medium or distributed through multiple storage mediums. In some embodiments, data may be stored in multiple database, multiple filesystems or a combination thereof.

Although the steps, operations, or computations may be presented in a specific order, this order may be changed in different embodiments. In some embodiments, some steps may be omitted. Further, in some embodiments, additional or alternative steps may be performed. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

It will be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the meaning of “in” includes “in” and “on” unless the context clearly dictates otherwise.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

Thus, while the invention has been described with respect to specific embodiments thereof, these embodiments are merely illustrative, and not restrictive of the invention. Rather, the description (including the Summary and Abstract) is intended to describe illustrative embodiments, features and functions in order to provide a person of ordinary skill in the art context to understand the invention without limiting the invention to any particularly described embodiment, feature or function, including any such embodiment feature or function described. While specific embodiments of, and examples for, the invention are described herein for illustrative purposes only, various equivalent modifications are possible within the spirit and scope of the invention, as those skilled in the relevant art will recognize and appreciate.

As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

What is claimed is:

1. A data processing system comprising:
a memory for storing vehicle inventory records and a machine learning current value model trained to output a prediction of current value, the machine learning current value model representing a set of vehicle features and historical secondary market transaction price;
a processor configured to;
receive electronic vehicle data regarding vehicles available from multiple sources;
store the electronic vehicle data in a set of inventory records, each inventory record in the set of inventory records including a set of vehicle attributes for a respective available vehicle:
for each inventory record in the set of inventory records:
extract the set of vehicle attributes for the respective available vehicle;
create a feature vector for the respective available vehicle based on the set of vehicle attributes extracted from the inventory record for the respective available vehicle; and
determine a current value for the respective available vehicle by processing the feature vector for the respective available vehicle using the machine learning current value model and update the inventory record for the respective available vehicle by adding the current value for the respective available vehicle to the inventory record for the respective available vehicle.

2. The data processing system of claim 1, wherein the processor is configured to:
receive electronic secondary market transaction data regarding multiple secondary market transactions involving secondary market vehicles sold on a secondary market;
store the electronic secondary market transaction data in a set of secondary market transaction records, each secondary market transaction record in the set of secondary market transaction records storing a set of attributes for a respective secondary market vehicle, the set of attributes for the respective secondary market vehicle including attributes for secondary market transaction price, make, model, age, mileage, exterior color, body type, fuel type, drive type, and price trend data for the respective secondary market vehicle;
create a secondary market transaction feature vector from each secondary market transaction record to create a set of secondary market transaction feature vectors, each secondary market transaction feature vector representing the set of attributes from a respective secondary market transaction record; and
train the machine learning current value model using the set of secondary market transaction records.

3. The data processing system of claim 1, wherein the set of vehicle features comprises make, model, trim, age, mileage, exterior color, body type, fuel type, drive type, price trend data and condition.

4. The data processing system of claim 1, wherein the machine learning current value model comprises:
a first machine learning model trained to output an initial prediction of current value, the first machine learning model representing a first set of vehicle features and a first set of historical secondary market transaction values; and
an adjustment to be applied to the initial predication of current value, the adjustment associated with a second set of vehicle features.

5. The data processing system of claim 4, wherein the adjustment comprises a vehicle condition adjustment.

6. The data processing system of claim 5, wherein the memory stores an auxiliary model, the auxiliary model trained to quantify a relationship between secondary market transaction value and condition, the auxiliary model representing the second set of vehicle features and a second set of historical secondary market values, wherein the first set of vehicle features is different than the second set of vehicle features.

7. The data processing system of claim 6, wherein the first set of vehicle features comprises make, model, trim, age, mileage, exterior color, body type, fuel type, drive type, and price trend data, and secondary market transaction price, and wherein the second set of vehicle features comprises features representing make, model, year, mileage, condition and secondary market transaction price.

8. The data processing system of claim 7, wherein determining the current value for the respective available vehicle comprises using the first machine learning model to determine an initial current value for the respective available vehicle and applying a coefficient determined from the auxiliary model to adjust the initial current value for the respective available vehicle to determine a final current value for the respective available vehicle based on a specified condition grade for the respective available vehicle.

9. The data processing system of claim 8, wherein the machine learning current value model includes a set of coefficients derived from the auxiliary model.

10. The data processing system of claim 1, wherein the processor is further configured to:
receive a request from a client device associated with a user to browse vehicles;
determine a set of payment information associated with the user;
determine a set of qualified vehicles for the user, wherein each vehicle in the set of qualified vehicles is determined to be qualified based on the set of payment information associated with the user and the current value determined for that qualified vehicle by the machine learning current value model; and
returning a user interface page to the client device to allow the user to browse the set of qualified vehicles determined for the user.

11. A non-transitory computer readable medium embodying thereon computer program code, the computer program code comprising instructions for:
executing a machine learning current value model trained to output a prediction of current value, the machine learning current value model representing a set of vehicle features and historical secondary market transaction values;
receiving electronic vehicle data regarding vehicles available from multiple sources;
storing the electronic vehicle data in a set of inventory records, each inventory record in the set of inventory records including a set of vehicle attributes for a respective available vehicle:
for each inventory record in the set of inventory records:
extracting the set of vehicle attributes for the respective available vehicle;
creating a feature vector for the respective available vehicle based on the set of vehicle attributes extracted from the inventory record for the respective available vehicle; and
determining a current value for the respective available vehicle by processing the feature vector for the respective available vehicle using the machine learning current value model and updating the inventory record for the respective available vehicle by adding the current value for the respective available vehicle to the inventory record for the respective available vehicle.

12. The non-transitory computer readable medium of claim 11, wherein the set of vehicle features comprises make, model, trim, age, mileage, exterior color, body type, fuel type, drive type, price trend data and condition.

13. The non-transitory computer readable medium of claim 11, wherein the machine learning current value model comprises:
a first machine learning model trained to output an initial prediction of current value, the first machine learning model representing a first set of vehicle features and a first set of historical secondary market transaction values; and
an adjustment to be applied to the initial predication of current value, the adjustment associated with a second set of vehicle features.

14. The non-transitory computer readable medium of claim 13, wherein the adjustment comprises a vehicle condition adjustment.

15. The non-transitory computer readable medium of claim 14, wherein the computer program code further comprises instructions to access an auxiliary model, the auxiliary model trained to quantify a relationship between secondary market transaction value and condition, the auxiliary model representing the second set of vehicle features and a second set of historical secondary market values, wherein the first set of vehicle features is different than the second set of vehicle features.

16. The non-transitory computer readable medium of claim 15, wherein the first set of vehicle features comprises make, model, trim, age, mileage, exterior color, body type, fuel type, drive type, and price trend data, and secondary market transaction price, wherein the second set of vehicle features comprises features representing make, model, year, mileage, condition and secondary market transaction price.

17. The non-transitory computer readable medium of claim 16, wherein determining the current value for the respective available vehicle comprises using the first machine learning model to determine an initial current value for the respective available vehicle and applying a coefficient determined from the auxiliary model to adjust the initial current value for the respective available vehicle to determine a final current value for the respective available vehicle based on a specified condition grade for the respective available vehicle.

18. The non-transitory computer readable medium of claim 17, wherein the machine learning current value model includes a set of coefficients derived from the auxiliary model.

19. The non-transitory computer readable medium of claim 11, wherein the computer program code comprises instructions for:
receiving a request from a client device associated with a user to browse vehicles;
determining a set of payment information associated with the user;
determining a set of qualified vehicles for the user, wherein each vehicle in the set of qualified vehicles is determined to be qualified based on the set of payment information associated with the user and the current value determined for that qualified vehicle by the machine learning current value model; and
returning a user interface page to the client device to allow the user to browse the set of qualified vehicles determined for the user.

20. The non-transitory computer readable medium of claim 11, wherein the computer program code comprises instructions for:
receiving electronic secondary market transaction data regarding multiple secondary market transactions involving secondary market vehicles sold on a secondary market;
storing the electronic secondary market transaction data in a set of secondary market transaction records, each secondary market transaction record in the set of secondary market transaction records storing a set of attributes for a respective secondary market vehicle, the set of attributes for the respective secondary market vehicle including attributes for secondary market transaction price, make, model, age, mileage, exterior color, body type, fuel type, drive type, and price trend data for the respective secondary market vehicle;
create a secondary market transaction feature vector from each secondary market transaction record to create a set of secondary market transaction feature vectors, each secondary market transaction feature vector representing the set of attributes from a respective secondary market transaction record; and
train the machine learning current value model using the set of secondary market transaction records.
